(19) United States
(12) Patent Application Publication
(10) Pub. No.: US 2021/0348845 A1
(43) Pub. Date: Nov. 11, 2021

(54) AIR PURIFYING FLOOR DRYER

(71) Applicant: Amano Pioneer Eclipse Corporation, Sparta, NC (US)

(72) Inventor: Derrick Lee Hamm, Sparta, NC (US)

(21) Appl. No.: 17/241,177

(22) Filed: Apr. 27, 2021

Related U.S. Application Data
(60) Provisional application No. 63/020,235, filed on May 5, 2020.

(51) Int. Cl. F26B 21/00

(52) U.S. Cl. CPC F26B 21/003

(57) ABSTRACT

The present invention provides a kit that may be added to existing floor dryers so that the dryers may purify the air it uses to dry floors while it dries the floors. The kit may be added to existing floor dryers or pre-installed on newly manufactured floor dryers. The kit includes an adapter that may be used to mount the kit to the intake of the dryer. It also includes an air filter that removes particulates from air drawn into the dryer. A UV light source is contained within the filter that also treats air drawn into the air dryer to kill microorganisms contained in the air before the air is blow out from the dryer to dry the floor.

### CROSS-REFERENCE TO RELATED APPLICATIONS

This application claims priority to U.S. Provisional Patent Application Ser. No. 63/020,235, filed on May 5, 2020, entitled “Air Purifying Floor Dryer,” currently pending, the entire disclosure of which is incorporated herein by reference.

### BACKGROUND OF THE INVENTION

Floor dryers, (also called air movers), are common tools that have long been used in order to dry floors. Floors may need to be dried for a number of reasons, including, but not limited to, water restoration, floor cleaning, or even to aid in the drying of a protective coating that has been applied to the floor. Such dryers are commonly used by workers in the custodial and restoration industries. The dryers come in various sizes and configurations, but can essentially be categorized into two groups, horizontal floor dryers and vertical floor dryers.

FIG. 1 illustrates an example of a prior art horizontal floor dryer 1. As known and understood in the art, the floor dryer 1 includes an intake 5 and a blower 10. The horizontal floor dryer 1 operates by receiving air at its intake 5 and subsequently blowing that air outwardly through its blower 10. The floor dryer 1 is considered to be a horizontal floor dryer because the intake 5 is oriented such that it is side-facing, or horizontal. In prior art floor dryers, such as the floor dryer 1, it is common for the blower 10 to be oriented at a 10-15° angle relative to the ground surface. In FIG. 1, the blower is positioned at such an angle with the assistance of a kickstand 15 that lifts the blower 10 off of the ground in order to achieve the appropriate angle. A blower such as the blower 10 is preferably positioned at such an angle so as not to blow air directly onto the floor surface but instead encourage air to circulate above the floor surface and more generally about the room in order to dry the floor surface.

FIG. 2 illustrates a second, alternatively constructed prior art floor dryer, which is referred to as a vertical floor dryer 20. Like the horizontal floor dryer 1, the vertical floor dryer 20 includes each of an intake 25 and a blower 30. Unlike the horizontal floor dryer 1, the intake 25 of the vertical floor dryer 20 is oriented such that it is facing upwards or in a vertical direction. The vertical orientation of the intake 25 is what gives the floor dryer 20 its name, the vertical floor dryer 20. Like the floor dryer 1, the blower 30 of the floor dryer 20 is oriented at an angle between 10 and 15 degrees. Unlike the floor dryer 1, however, the floor dryer 20 does not include a kick-stand, and instead includes a pair of leg members 35 (only one of which is illustrated in FIG. 2) that project downwardly from the blower 30 in order to maintain the blower 30 at a preferred angle such as the 10-15° set forth above.

FIG. 3 illustrates yet another third, alternately constructed prior art floor dryer, which is referred to as a whole room vertical floor dryer 40. The whole room vertical floor dryer 40 includes an intake 45 and a blower (not illustrated). The intake 45 of the whole room vertical floor dryer 40 is oriented such that it is facing upwardly, or in a vertical direction. The blower is facing downwardly, in an opposite vertical direction of the intake 45. Unlike floor dryers 1, 20, whole room vertical floor dryer 40 includes a set of wheel casters 50 that support the dryer 40 and aid in its movement.

Floor dryers such as the dryers 1, 20, 40 are inexpensive, and are commonly and frequently used by professionals who clean and maintain commercial and industrial facilities. However, they are principally used in order to move air in order to facilitate and speed up the floor drying process. They do not treat or otherwise purify air that circulates through them.

One known dryer exists in the market in which a HEPA filter is added to a dryer such as the dryer 1 or the dryer 20 in order to attempt to remove particulates from the air when the dryer is in operation. However, such a HEPA filter does not kill any microorganisms.

Air sanitizers, purifiers, and disinfectors are commercially available and are increasing in popularity. Such appliances have the ability to improve indoor air quality while also killing microorganisms. However, such appliances are expensive and do not aid in the floor drying process.

### SUMMARY OF THE INVENTION

The present invention provides a kit that may be added to a traditional floor dryer, such as the floor dryers 1, 20, 40. The kit preferably includes each of a HEPA filter and an ultraviolet (“UV”) light source such that the floor dryer improves indoor air quality and also kills microorganisms. The kit provides the air improvement features that air purifiers offer, but also effectively dries floors. The invention may be provided as a kit such that it can be installed on various models of floor dryers by a customer or a user. The installation of such a kit is simple and requires no special tools or skills. Alternatively, the “kit” of the improved floor dryer may be pre-installed by the manufacturer or distributor of floor dryers.

### BRIEF DESCRIPTION OF THE DRAWINGS

FIG. 1 is a perspective view of a prior art horizontal floor dryer.

FIG. 2 is a perspective view of a prior art vertical floor dryer.

FIG. 3 is a perspective view of a prior art whole room vertical floor dryer.

FIG. 4 is a perspective view of an air purifying floor dryer constructed according to the teachings hereof.

FIG. 5 is an exploded view of the kit that is installable to an existing air purifying floor dryer.

### DETAILED DESCRIPTION OF THE INVENTION

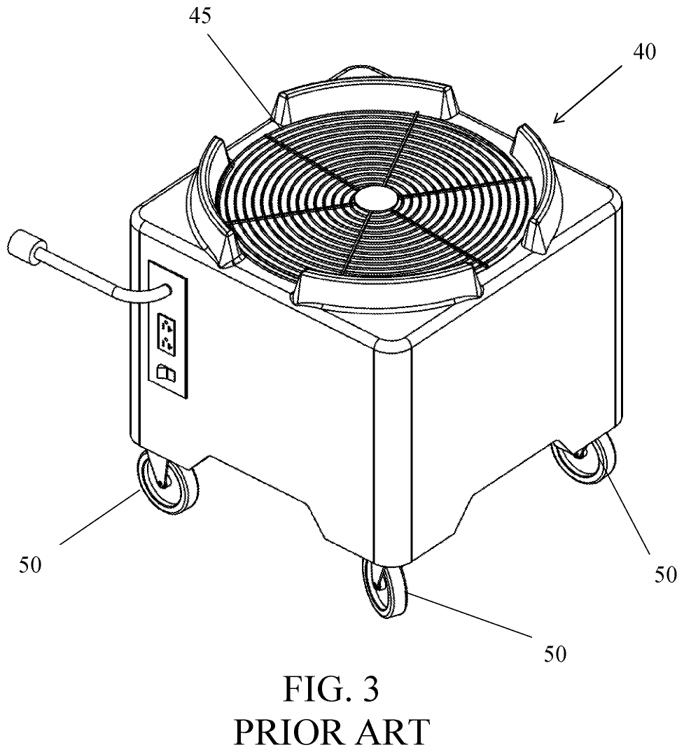

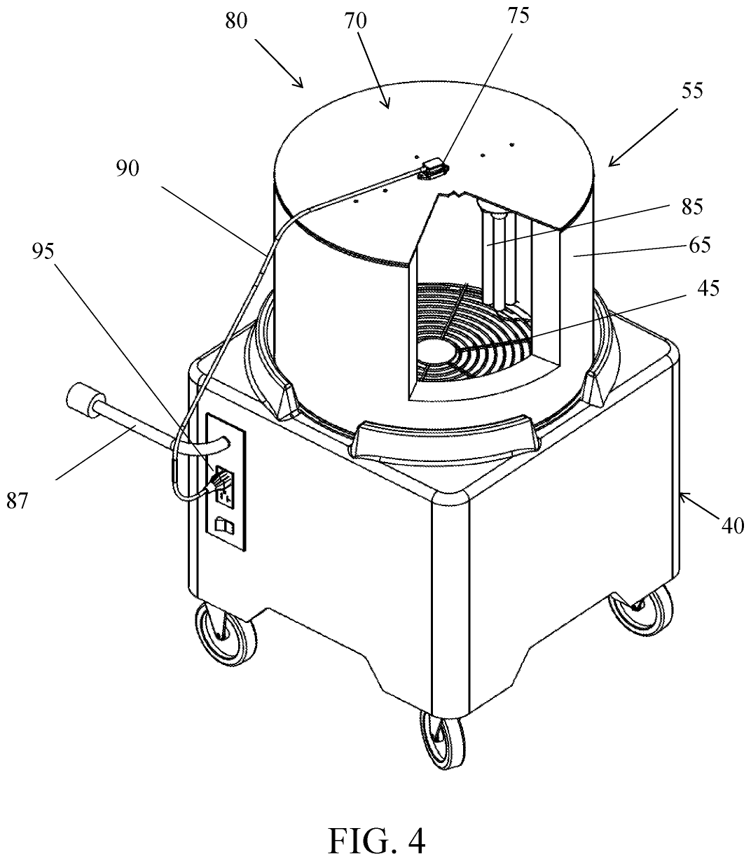

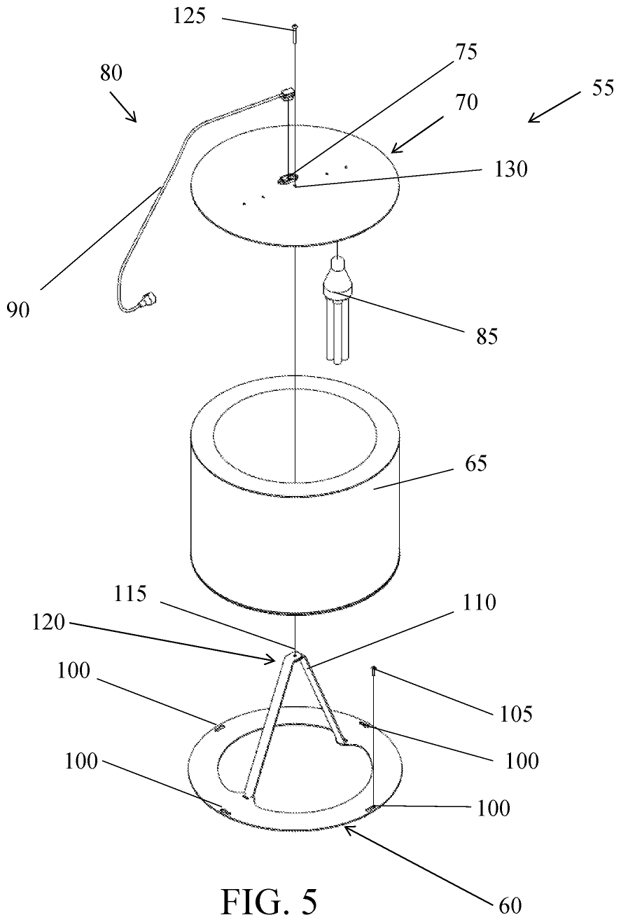

FIG. 4 provides an improvement to the whole room vertical floor dryer 40 illustrated in FIG. 3. More specifically, FIG. 4 illustrates the floor dryer 40 with an air purifying kit 55 installed thereto. The purifying kit 55, which is illustrated in exploded view in FIG. 5, generally includes each of an adapter 60 (see FIG. 5), filter 65, end cap 70, receptacle 75 provided on the end cap 70 (the end cap 70 and the receptacle 75 both at an upper portion 80 of the kit 55), and a UV light source 85 contained within the filter 65. The UV light source 85 is visible in each of FIGS. 4 and 5. The UV light 85 is visible in FIG. 4 because a section of the filter 65 has been removed for easier viewing.

The filter 65 provided in FIGS. 4 and 5 is preferably a HEPA filter that protrudes upwardly from the adapter 60 and thus the floor dryer 40. In some embodiments, the HEPA filter may be surrounded by a pre-filter (not illustrated). In operation, air that is drawn into the floor dryer 40 via the intake 45 first preferably passes through the filter 65 such that particulates are removed from the air.

Within the filter 65, the UV light source 85 may use known or foreseeable methods and systems to treat air that is drawn into the floor dryer 40 via the intake 45 and the filter 65 by illuminating the air with UV light. The UV light may kill microorganisms that are present in air that is drawn into the floor dryer 40.

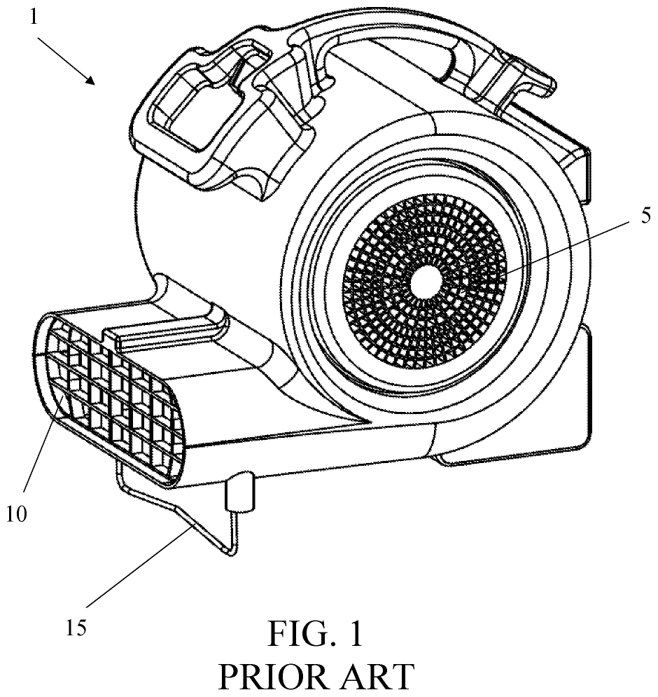

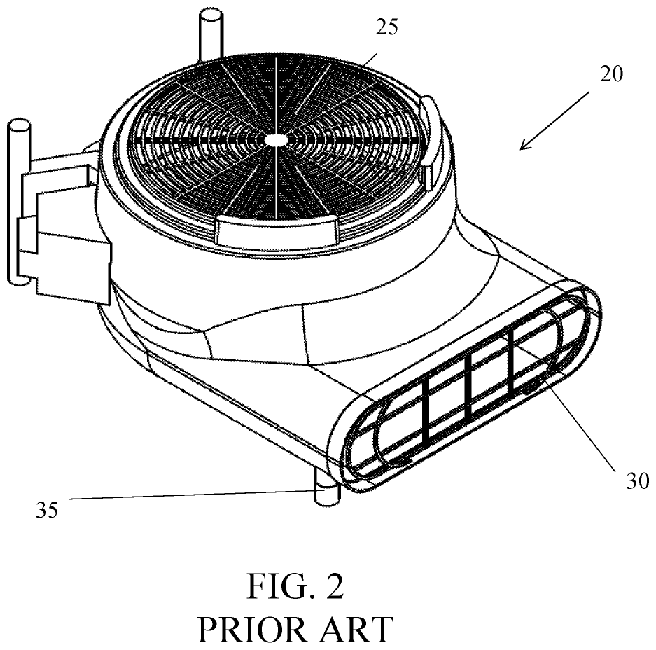

When a cord such as cord 87 is plugged into a power source (not illustrated), power may be provided to the dryer 40 such that it can carry out its known and understood operation of drawing air through the intake 45 and expelling air through the blower (or in the case of FIGS. 1 and 2, through the intakes 5, 25 and from the blowers 10, 30, respectively). The end cap 70 may be located at the upper portion 80 of the filter 65, with the receptacle 75 located thereon. The receptacle 75 may include an electrical outlet (e.g., a three-pronged outlet) to which a cord, such as cord 90, may be coupled. When the cord 90 is plugged into a power source such as outlet 95 provided in the dryer 40, power may be provided to the UV light source 85 via the receptacle 75 such that it may provide power thereto. That way, the UV light may be illuminated within the filter 65 such that it can treat air that is drawn into the dryer 40 via the filter 65. In alternative embodiments, a single power source may be provided to operate the UV light and the dryer 40 (or dryer 1, 20) and its drying functions.

The adapter 60 is preferably attached to the floor dryer 40 at its intake 45. The adapter 60 may be mounted to the floor dryer 40, for example via screw holes 100 and screws 105 that are positioned to align with pre-existing holes (not illustrated in the dryer 40), though a number of ways are foreseeable. For example, it may be friction-fit to the intake 45. Alternatively, it may be snapped or otherwise releasably attached to the dryer 40. The adapter 60 may operate to attach the kit 55 to an existing floor dryer such as the dryer 40 with little effort or technical skill.

The adapter preferably includes a V-shaped support member 110 that extends upwardly from the adapter 60. The V-shaped member preferably includes an aperture 115 at an upper end 120 through which a fastener 125 may be received. The fastener 125 may also be received through an aperture 130 in the end cap 70 to secure the end cap 70 to the adapter 60. The filter 65 is preferably placed between the end cap 70 and the adapter 60. The filter 65 is further secured in place when the fastener 125 engages the end cap 70 to the adapter 60. Because the fastener 125 is easily disengageable to unsecure the adapter 60 and the end cap 70 from one another, it is easy for a user to replace the filter 65 at the end of its useful life. A user may do so by placing a new filter 65 between the adapter 60 and the end cap 70 before resecuring the adapter 60 and the end cap 70 to one another, thus securing the new filter 65 therebetween.

It should be noted that in alternative embodiments, the kit 55 may be provided as pre-installed on a dryer such as the dryer 1, 20, 40. It should also be noted that the kit 55 that is provided in FIG. 4 may be mountable to the floor dryer 20 the same way it can be mounted to the dryer 40, as described above. The kit 55 may also be attachable to the dryer 1 by installing it such that it covers the intake 5 that is horizontally-oriented rather than the vertically-oriented intakes 25, 45.

In operation, air drawn into the dryer 40 via the filter 65 first moves through the filter 65 such that particulates are substantially removed. Subsequently, the air passes by the UV light provided by the UV light source 85 contained within the filter 65 such that a substantial number of microorganisms within the air are killed. Air may then be expelled through the bottom of the dryer 40 via its blower (or in the embodiments of FIGS. 1 and 2, the blowers 10, 30 at the front of the dryers 1, 20, respectively). Similarly to a traditional air purifier, upwards of 99.97% of particles that are 0.3 microns or larger are captured by the HEPA filter. In addition, microorganisms may be killed by the UV light as they pass in close proximity to the light.

The above-described design allows existing floor dryers such as the dryers 1, 20, 40 to easily be converted to air sanitizers, purifiers, or disinfectors without having to purchase a dedicated machine. The kit 55 can be used with various models of dryers, including but not limited to, the dryers 1, 20, 40.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A floor dryer, the floor dryer comprising:
an intake;
a blower; and
a kit selectively mountable to the intake, the kit including:
a filter for filtering air drawn into the dryer via the intake; and
a UV light source within the filter for treating air drawn into the dryer via the intake before the air is blown from the dryer via the blower.

2. The floor dryer of claim 1, wherein the filter is a HEPA filter.

3. The floor dryer of claim 1, wherein the kit includes an adapter that selectively engages the floor dryer to the kit.

4. The floor dryer of claim 3, wherein the adapter includes an upward-extending bracket that is selectively engageable with an end cap of the kit to retain the filter within the kit.

5. The floor dryer of claim 1, wherein the kit is configured to attach to a vertical air dryer and a horizontal air dryer.

6. The floor dryer of claim 3, wherein the kit includes an end cap placed above the filter that may be attachable to the adapter.

7. The floor dryer of claim 1, wherein a receptacle is provided in the kit in electrical communication with the UV light source.

8. The floor dryer of claim 7, wherein the kit includes a cord that is electrically connected to the receptacle, the cord being selectively engageable with a power outlet.

9. The floor dryer of claim 7, wherein the cord is engageable with a power outlet on the floor dryer.

10. The floor dryer of claim 1, wherein the kit includes a pre-filter that surrounds the filter.

11. A kit that is selectively engageable with a floor dryer, the kit comprising:
a filter for filtering air drawn into the dryer via the intake; and
a UV light source within the filter for treating air drawn into the dryer via the intake before the air is blown from the dryer via the blower.

12. The kit of claim 11, wherein the filter is a HEPA filter.

13. The kit of claim 11, wherein the kit includes an adapter that selectively engages the floor dryer to the kit.

14. The kit of claim 13, wherein the adapter includes an upward-extending bracket that is selectively engageable with an end cap of the kit to retain the filter within the kit.

15. The kit of claim 11, wherein the kit is configured to attach to a vertical air dryer and a horizontal air dryer.

16. The kit of claim 13, wherein the kit includes an end cap placed above the filter that may be attachable to the adapter.

17. The kit of claim 11, wherein a receptacle is provided in the kit in electrical communication with the UV light source.

18. The kit of claim 17, wherein the kit includes a cord that is electrically connected to the receptacle, the cord being selectively engageable with a power outlet.

19. The floor dryer of claim 17, wherein the cord is engageable with a power outlet on the floor dryer.

20. The kit of claim 11, wherein the kit includes a pre-filter that surrounds the filter.
